(19) United States
(12) Patent Application Publication
(10) Pub. No.: US 2014/0067472 A1
(43) Pub. Date: Mar. 6, 2014

(54) System and Method For Segmenting A Customer Base

(71) Applicants: Daniel Mayes, Normal, IL (US); Nancy K. Armstrong, Towanda, IL (US); Jeffrey D. Arseneau, Normal, IL (US); Kevin Cote, Bloomington, IL (US); Brandon L. Emlen, Goodfield, IL (US); Craig W. Fisher, Bloomington, IL (US); Thomas H. Park, Glen Mills, PA (US); Elizabeth Pulver, Bloomington, IL (US); Laurette C. Stiles, Bloomington, IL (US); Laurel K. Straub, Bloomington, IL (US); Eric Webster, Bloomington, IL (US); Lindsay Wilson, Bloomington, IL (US)

(72) Inventors: Daniel Mayes, Normal, IL (US); Nancy K. Armstrong, Towanda, IL (US); Jeffrey D. Arseneau, Normal, IL (US); Kevin Cote, Bloomington, IL (US); Brandon L. Emlen, Goodfield, IL (US); Craig W. Fisher, Bloomington, IL (US); Thomas H. Park, Glen Mills, PA (US); Elizabeth Pulver, Bloomington, IL (US); Laurette C. Stiles, Bloomington, IL (US); Laurel K. Straub, Bloomington, IL (US); Eric Webster, Bloomington, IL (US); Lindsay Wilson, Bloomington, IL (US)

(73) Assignee: STATE FARM MUTUAL AUTOMOBILE INSURANCE COMPANY, Bloomington, IL (US)

(21) Appl. No.: 13/598,481

(22) Filed: Aug. 29, 2012

(51) Int. Cl. G06Q 30/02

(52) U.S. Cl. 705/7.32

(57) ABSTRACT

A method and apparatus may segment a business' customer base and determine one or more business behaviors toward customers based on the segmentation. For example, the method and apparatus may communicate a survey to a plurality of customers including at least one needs-based question and at least one demographics question. The method and apparatus may also group received survey data into a plurality of segments. Using sets of received survey data, the method and apparatus may also classify each of the plurality of customers into a segments based on the received numerical values. The numerical values for each customer data set may correspond to one of the plurality of segments. The method and apparatus may then determine one or more needs of each customer based on the segment and a customer data set and determine a prerequisite business behavior for each segment based on the determined needs of each customer.

### TECHNICAL FIELD

The present disclosure generally relates to a system and method for segmenting customers of a particular type of business and modifying business behavior toward those customers based on the customer base segmentations.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Segmentation is a process by which a business refines its understanding of a long-term customer market in order to take tactical steps to better address customer needs and, therefore, expand the business. Segmentation enables growth by understanding the personal preferences and needs of different types of customers. Segmentation data typically includes ethnography to deepen business' understanding of various segments and practices to understand the most important customer needs. Using this information, businesses may develop sales and marketing approaches to maximize the business' growth potential. Generally, segmentation is a foundation that allows a business organization to align its operations, resources, marketing and sales to best attract the most customers. Some businesses may use segmentation to provide different products to identified groups of customers to expand or continue the business. For example, an insurance carrier may provide pricing discounts based on tenure with the company to improve customer retention.

### SUMMARY

An enterprise-wide, strategic segmentation system and method may allow a business to align its practices to maximize its growth. The business may customize the role of its agents or sales associates to meet particular customer needs, develop a targeted marketing campaign that attracts target customers, create product bundles tailored to customer's needs, develop scripts for customer call centers to better communicate with current and potential customers, and other actions to directly improve the customer experience and grow the business.

In some embodiments, a computer-implemented method may segment a business' customer base and determine one or more business behaviors toward customers based on the segmentation. For example, the method may communicate a survey to a plurality of customers, the survey including at least one needs-based question and at least one demographics question, wherein the needs-based question indicates a customer prerequisite for a business behavior and the demographics question indicates an objective fact about a customer. The method may also receive survey data in response to the survey questions, the survey data including a plurality of customer data sets, each set including numerical values corresponding to each response to the survey questions. The method may further group the received survey data into a plurality of segments and classify each of the plurality of customers into one of the plurality of segments based on the numerical values corresponding to each response to the survey questions for a customer data set. The numerical values for each customer data set may correspond to one of the plurality of segments. Still further, the method may determine one or more needs of each customer based on the segment and the customer data set corresponding to the customer, the one or more needs for each customer indicating the customer prerequisite for the business behavior, and, finally, determine one or more prerequisite business behaviors for each segment based on the determined one or more needs of each customer.

In other embodiments, a computer device may segment a business' customer base and determine one or more business behaviors toward customers based on the segmentation. The computer device may comprise one or more processors and one or more memories coupled to the one or more processors. The one or more memories may include computer executable instructions stored therein that, when executed by the one or more processors, cause the one or more processors to perform a plurality of functions. For example, the functions may cause the one or more processors to communicate a survey to a plurality of customers, the survey including at least one needs-based question and at least one demographics question. The needs-based question may indicate a customer prerequisite for a business behavior and the demographics question may indicate an objective fact about a customer. The functions may also cause the one or more processors to receive survey data in response to the survey questions, the survey data including a plurality of customer data sets. Each set may include numerical values corresponding to each response to the survey questions. Further, the functions may cause the one or more processors to group the received survey data into a plurality of segments and classify each of the plurality of customers into one of the plurality of segments. Still further, the functions may also cause the one or more processors to determine one or more needs of each customer based on the segment and the customer data set corresponding to the customer, the one or more needs for each customer indicating the customer prerequisite for the business behavior, and determine one or more prerequisite business behaviors for each segment based on the determined one or more needs of each customer.

In still other embodiments, a tangible computer-readable medium may include non-transitory computer readable instructions stored thereon for segmenting a business' customer base and determining one or more business behaviors toward customers based on the segmentation. The instructions may comprise communicating a survey to a plurality of customers. The survey may include at least one needs-based question and at least one demographics question, wherein the needs-based question indicates a customer prerequisite for a business behavior and the demographics question indicates an objective fact about a customer. The instructions may also receive survey data in response to the survey questions, the survey data including a plurality of customer data sets, each set including numerical values corresponding to each response to the survey questions. Further, the instructions may group the received survey data into a plurality of segments the received survey data by clustering the survey data and executing a hierarchical analysis followed by a K-means analysis of the received survey data. The instructions may then classify each of the plurality of customers into one of the plurality of segments. Finally, the instructions may determine one or more needs of each customer based on the segment and the customer data set corresponding to the customer, the one or more needs for each customer indicating the customer prerequisite for the business behavior, and determine one or more prerequisite business behaviors for each segment based on the determined one or more needs of each customer.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 illustrates a block diagram of a computer-implemented system for segmenting a customer base in accordance with the described embodiments;

FIG. 2 illustrates one embodiment of a data structure for organizing and presenting information describing a customer segment as a result of a segmentation analysis, as described herein;

FIG. 3 illustrates an exemplary user interface for a segmentation tool;

FIG. 4 illustrates one embodiment of a data structure relating customer needs to various customer interaction points for a particular customer segment;

FIG. 5 illustrates one embodiment of a data structure relating particular business behaviors to customer segments during points of customer interaction between the business and the customer;

FIG. 6 illustrates one embodiment of a flowchart for a method for segmenting a customer base for a business and implementing specific business behaviors for customers according to their segment; and

FIG. 7 illustrates a block diagram of a computer to implement the various functions for segmenting a customer base in accordance with the described embodiments.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

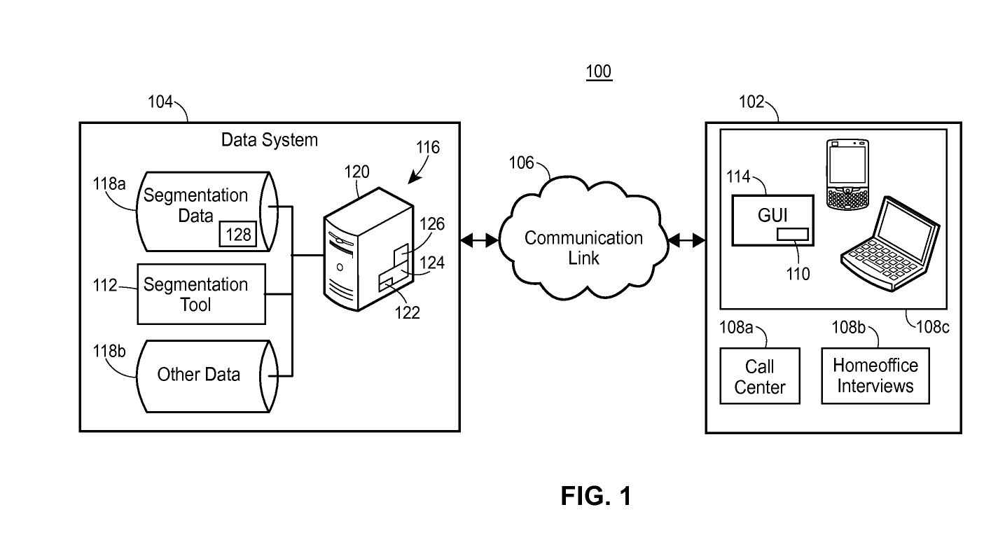

With reference to FIG. 1, a system 100 for segmenting a customer base may include front end components 102 and backend components 104 in communication with each other via a communication link 106 (e.g., computer network, telephone system, in-person communication, etc.). FIG. 1 illustrates a block diagram of a high-level architecture of a computer segmentation system 100 including various software and hardware components or modules that may employ a method to segment a customer base. The various modules may be implemented as computer-readable storage memories containing computer-readable instructions (i.e., software) for execution by a processor of the computer system 100. The modules may perform the various tasks associated with generating customer segments, classifying customers for those segments, and employing particular behaviors toward those segmented customers during critical business interaction points, as herein described. The computer system 100 also includes both hardware and software applications, as well as various data communications channels for communicating data between the various hardware and software components.

The segmentation system 100 may include various entities at the front end 102 that may communicate survey data to the backend components 104 to complete segmentation of a customer base. For example, the front end components 102 may include a call center 108a that communicates data to the back end components via a telephone system, home office interviews 108b, and a computing device 108c that is capable of executing a graphical interface (GUI) 110 for a segmentation tool 112 within a web browser 114. In some embodiments, a computing device 108c executes instructions of a network-based data system 116 to receive segmentation data 118a and other data 118b at the front end components 102 via the computer network 106 for display in the GUI 110. The front end components 102 may receive the data 118a, 118b from the back end components 104 via the computer network 106 from execution of a segmentation tool 112. The device 108c may include a personal computer, smart phone, tablet computer, or other suitable computing device. The GUI 110 may communicate with the system 116 through the Internet 106 or other type of suitable network (e.g., local area network (LAN), a metropolitan area network (MAN), a wide area network (WAN), a mobile, a wired or wireless network, a private network, a virtual private network, etc.). A system server 120 may send and receive information and data 118a, 118b, for the system 100 such as computer-executable instructions and data associated with applications executing on the computing device 108c. The applications executing within the system 100 may include cloud-based applications, web-based interfaces to the data system 116, software applications executing on the computing device 108c, or applications including instructions that are executed and/or stored within any component of the system 100. The applications, GUI 110, browser 114, and tool 112 may be stored in various locations including separate repositories and physical locations.

In some embodiments, the data system 116 in general and the server 120 in particular may include computer-executable instructions 122 stored within a memory 124 of the server 114 and executed using a processor 126. The instructions 122 may instantiate a segmentation tool 112 or send instructions to the computing device 108c to instantiate a GUI 110 for the tool 112 using a web browser application 114 of a computing device 108c. In some embodiments, the browser application 114, GUI 110, segmentation tool 112, and elements of the data system 116 may be implemented at least partially on the server 120. The data system 116 and processor 126 may execute instructions 122 to display the GUI 110 including the data 118a, 118b within a display of the computing device 108c. The GUI 110 may allow a user to access various data 118a, 118b within the data system 116, edit or add data to the system 100, and other actions with the system data.

The segmentation data 118a may include survey data 128 gained through a detailed segmentation study. The system 100 may receive the survey data 128 through various methods including an on-line environment (e.g., the computing device 108c), telephonically (e.g., the call center 108a), or even during an in-person interview 108b. There are various methods to perform market segmentation. For example, a business may segment its market using psychographic, demographic, and behavior segmentation. In psychographic segmentation, a market may be segmented based on customers' feeling or “peace of mind” about the business. Demographic segmentation considers objective characteristics of customers such as age, number of children, occupation, etc. Behavior segmentation considers how customers actually act in the market with the business' product and is based on the current technological and competitive landscape. These methods of segmentation tend to be narrowly focused on the customer base and are useful in some studies. However, a “holistic” view of the marketplace in a needs-based segmentation strategy may provide a better view of a business' customer base and segmentation needs. For example, a needs-based segmentation may be more stable than a demographic or behavioral segmentation because it is based on needs shaped by an individual's experiences and nature that is fortified over time. A need state segmentation may exclude variables that are dependent on the current technological and competitive landscape and, thus, be more useful and stable to a business over time.

However, developing a practical way to implement a needs-based segmentation strategy within daily business practices may present a difficult and unique challenge. Needs-based market segments may be based on the application of advanced inferential statistical techniques to a large, statistically relevant sample group.

Generally, to determine segments, survey questions may be identified as correlated and independent. Further, mathematical analyses may determine which factors create clusters. In some embodiments, using a survey 128 with a mix of needs based questions and demographics questions may best drive the survey results into various clusters (e.g., approximately sixteen needs based questions and approximately two demographics questions). A hierarchical analysis followed by K-means analysis of the survey results may then produce the various segments.

Of course, various steps must be taken during the survey process to ensure that the sample is not skewed. For example, systematic population bias may result when the survey is conducted for convenience rather than sample accuracy (e.g., a sample of people taken from a single location during a short time period). To ensure accuracy, the sample should be random and representative. In some embodiments, the sample conforms generally to U.S. census data. Furthermore, migration between the segments may skew accuracy of the survey. For example, customers may change needs groups based on life stage changes (e.g., having children) and financial situation (e.g., customer used to choose insurance by price, but now chooses for peace of mind). However, a needs-based methodology for segmentation may present a stable model over time.

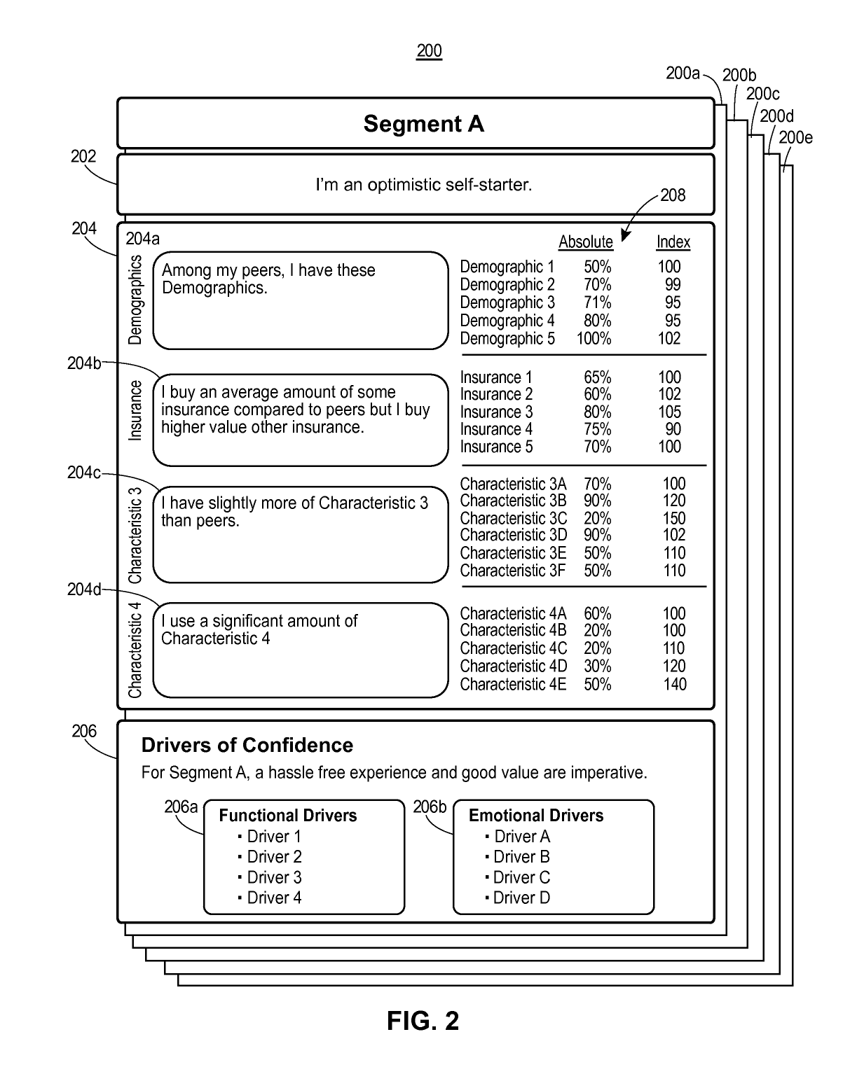

With reference to FIG. 2, the survey and market analysis generally described above may discover a number of data structures 200, including segments 200a, 200b, 200c, 200d, and 200e within a business' customer base. These segments 200a, 200b, 200c, 200d, and 200e may be stored as survey data 128 within the segmentation data repository 118 of the system 100. While the segments 200a, 200b, 200c, 200d, and 200e and methodologies are described herein as involving the insurance industry, a person of ordinary skill in the art of marketing and customer analysis may understand that the segments may generally apply to any industry or business enterprise. The segments 200a, 200b, 200c, 200d, and 200e of FIG. 2 may generally include data and indications of customer characteristics that will drive certain customers possessing these characteristics toward a business. Of course, an analysis of the data 128 may indicate any number of segments and the segments 200a, 200b, 200c, 200d, and 200e of FIG. 2 are only illustrative of the type of segmentation that may be possible using the survey data 128. One example segment 200a (Segment A of FIG. 2) may include summary statement data 202, segment characteristic data 204, and drivers data 206. The summary statement data 202 may include text describing the type of customer that may be included within this segment 200a. The statement data 202 may be based on the characteristic data 204 and drivers data 206. The characteristic data 204 may include survey data 128 that has been divided into particular categories that relate to areas of the business. For example, the characteristic data 204 may include survey data for demographics 204a, insurance 204b, and other categories 204c, 204d that, using the survey data, a business may find indicative of customers within a segment for the business. Each category may include a summary statement as well as analysis results 208 of the survey data 128 supporting the statements. Driver data 206 may include text data derived from the survey data 128 that describes those experiences which draw a customer in this segment 200a to the business. The driver data 206 may include functional driver data 206a and emotional driver data 206b. Functional driver data 206a may include survey data 128 indicating particular actions a business may take to draw a customer in this segment to the business. Emotional driver data 206b may include survey data 128 that indicates what feelings a customer in this segment 200a may need to experience in order to continue or draw more customers within this segment 200a to the business. Other segments 200b, 200c, 200d, and 200e, for example, may include data categories 202, 204, and 206 but with different descriptions and data indicating other segments of a business' customer base. Of course, analysis of a customer data 118a may indicate any number and type of segments and data that may be used to attract or retain customers having particular characteristics and other data.

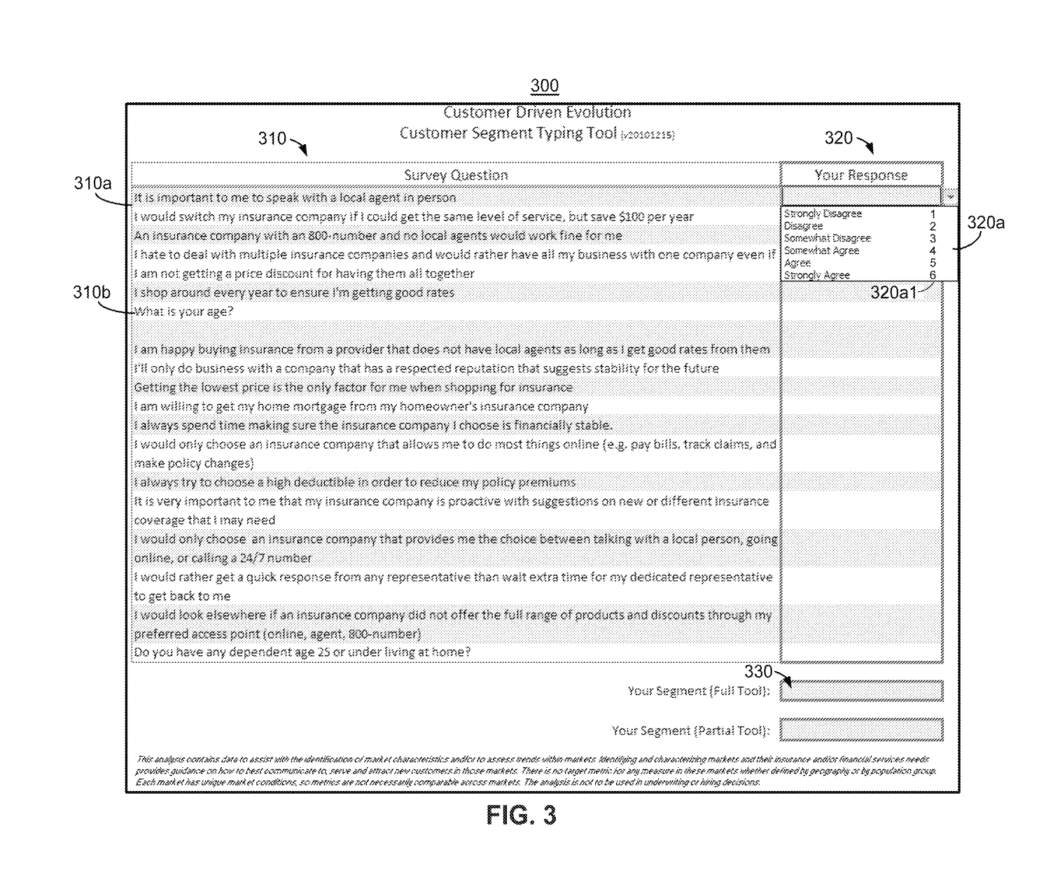

With reference to FIG. 3, a user interface 300 for the segmentation tool 112 may allow the system 100 to collect segmentation data 118a, survey data 128, and other data 118b to segment a customer base. In some embodiments, the interface 300 may include a plurality of survey questions 310 and selectable responses 320. The questions may include a collection of statements that elicit corresponding responses 320. In some embodiments, using the interface includes a mix of needs based questions and demographics questions may best drive the survey results into various clusters (e.g., approximately sixteen needs based questions and approximately two demographics questions). Each question 310 may elicit a subjective or objective response from the customer at the computing device 102. For example, a needs-based question 310a may include a statement of how important personal interaction with an agent of a business is to a current or potential customer. A response to such a question may indicate a degree of importance 320a for such interaction. A “strongly agree” response to a needs-based question 310a may indicate that the need expressed by the question is a prerequisite business behavior that the business must follow for the customer corresponding to that response. An objective or demographics question 310b may include a statement or question of facts about the customer such as age, residence zip code, number of dependents living at home, etc. Possible responses to demographics questions 310b may indicate choices to satisfy the question's fact statement. Each response 320a may also correspond to one or more numerical values 320a1. Selection of a response 320 to a question 310 may allow the segmentation tool 112 (FIG. 1) to use one or more of the values 320a1 to develop segments 330 for the plurality of customers taking the survey at the computing device 102.

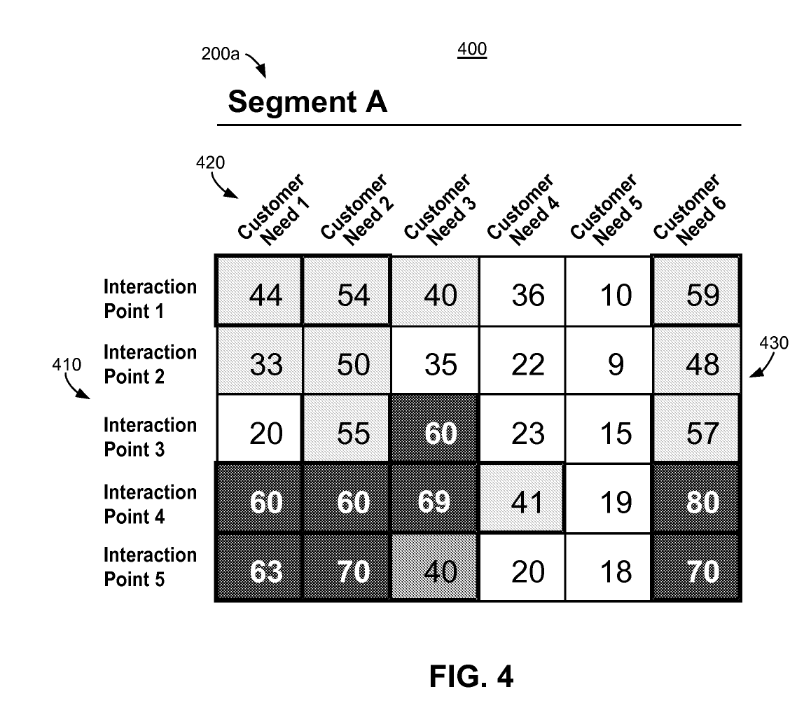

In some embodiments, the system 100 may employ the segmentation tool 112 and user interface 300 at different interaction points with the customer. An interaction point may include a part or service of an ongoing business relationship that forms the core of a particular business enterprise. With reference to FIG. 4, the system 100 may collect survey and other data 118a, 118b, 128 using the segmentation tool 112 and user interface 300 at various interaction points 410 of an ongoing business relationship. A data structure 400 may illustrate one or more relationships between the segmentation data. For example, where the business includes an insurance relationship, interaction points 410 may include: while the customer is researching an insurance product, while the customer is obtaining a quote for a type of insurance, when the insurance company issues an oral or verbal agreement of coverage before the company officially issues a policy and while the company issues the policy, when a customer has a claim against the policy, and while the customer needs to amend or edit a policy or account. Of course, each business may include its own type of interaction point depending on the type of business or the emphasis the business places on each interactin point. The questions 310 may be grouped into various categories of customer needs 420 indicating particular categories of business characteristics which the customers associated with various segments 200a, etc., may find helpful during the interaction point 410. Customers making up a particular segment (e.g., 200a, etc.) may provide responses 320 having values 310a1 within the various needs 420. The segmentation tool 112 may then analyze the response values 320a1 within each category of need 420 to calculate an interaction point need value 430. This value 430 may be an indication of how important each need 420 is to a particular segment 200a during a particular interaction point 410. For example, the segmentation tool 112 may determine that 44% of the customers identified within Segment A 200a may have responded that the ability to conduct a Research interaction at their convenience (e.g., twenty-four hours a day, seven days a week) is a somewhat important characteristic of an insurance company. The segmentation tool 112 may, thus, determine the needs of customers at interaction points 410. Once the segmented customers' needs are known, then the business may modify its interaction with the customer accordingly. For example, the tool 112 may determine that, during a claims interaction point 410, customers identified within Segment A 200a need continuous, 24/7 access to information, the ability to get information from a variety of channels (i.e., web, agent call, office visit, etc.), a highly-responsive business, and a high degree of expertise. Once the needs of each type of customer at each interaction point are known, then the business may modify its behavior toward that customer to retain or increase customer satisfaction and, thus, sales.

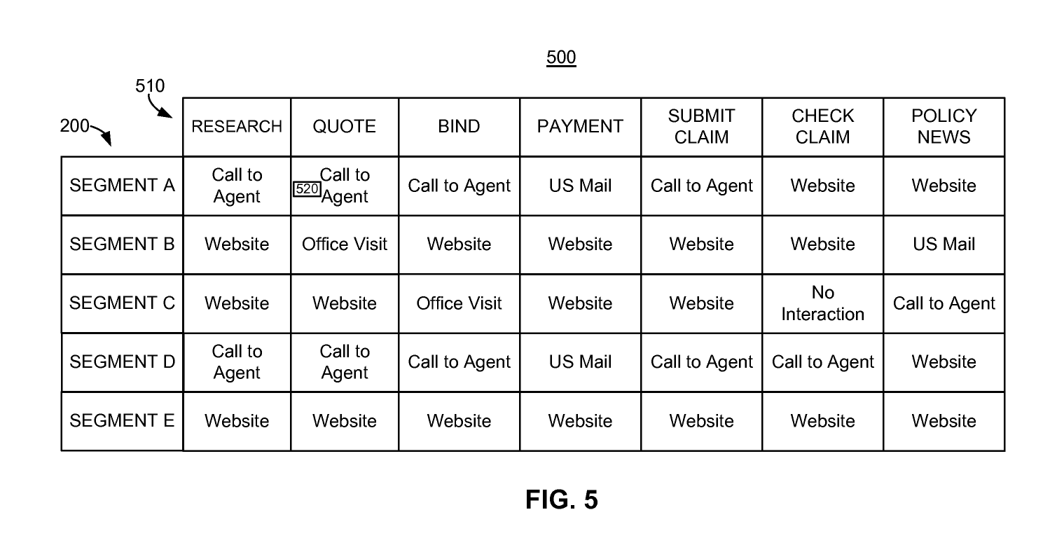

With reference to FIG. 5, results and analysis of the survey data 118a, 118b, 128 may be consolidated in a data structure 500 to indicate a particular behavior that the business should follow with each segment 200 during particular interaction points with the business in order to meet customer needs. As described above at FIG. 4, a business may interact with a customer within a segment 200 at interaction points 510. After the segmentation tool 112 indicates a customer should be classified within a particular segment 200 (FIG. 2), and the tool 112 calculates a score or percentage to identify the most important customer needs at each interaction point 410 (FIG. 4), then the system 100 may determine how a customer need may be met within the particular segment by matching an interaction point 510 with a segment 200 to determine the behavior 520. For example, the system 100 may classify a customer as being a member of Segment A. During the “Quote” interaction point, when the customer needs information for the price of an insurance policy, the system 100 may select a “Call to Agent” behavior for that customer over an “Office Visit” or “Website” behavior based on that customer's identity within Segment A. Similarly, the system 100 may determine other behaviors 520 corresponding to other interaction points 510 for each customer that has been classified as a member of a particular segment 200.

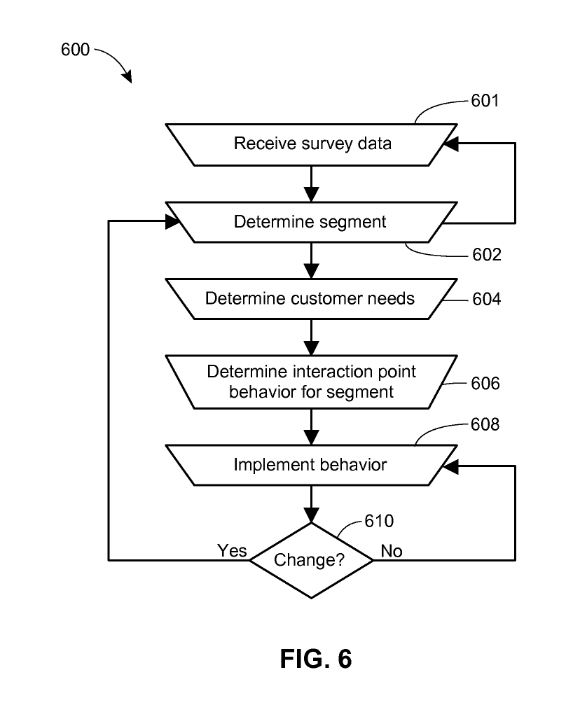

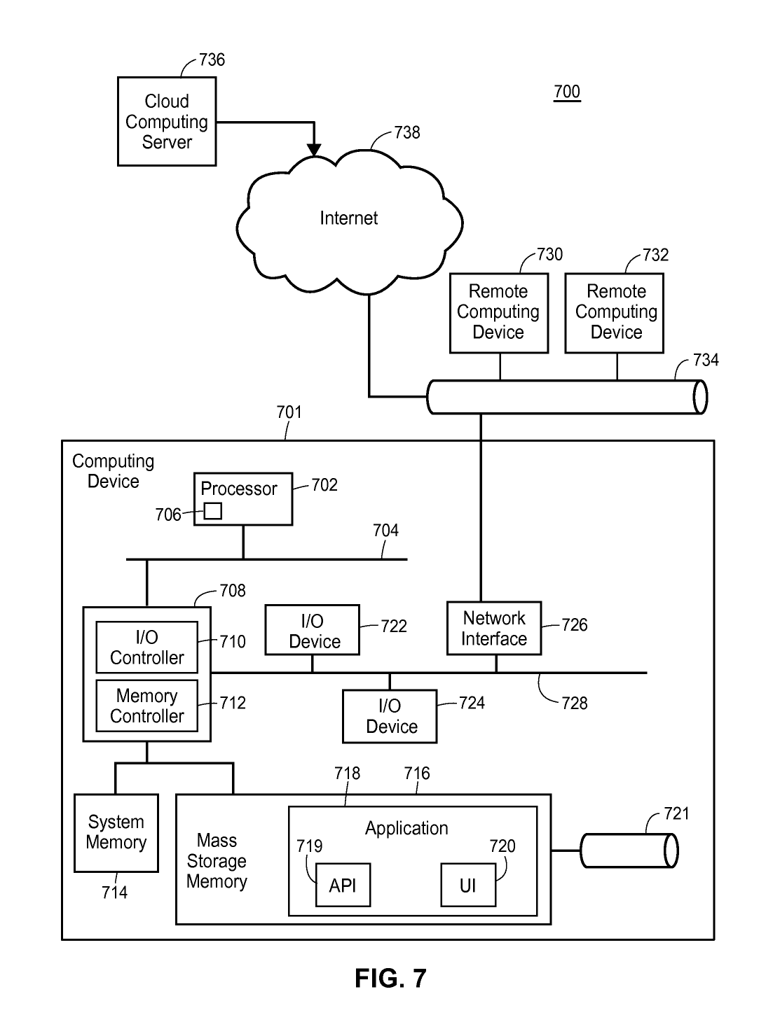

With reference to FIG. 6, the system 100 described herein may be employed in a method 600 (FIG. 6) to generate customer segments, classify customers for those segments, and employ particular behaviors toward those segmented customers during critical business interaction points. The method 600 may include one or more functions or routines in the form of non-transitory computer-executable instructions that are stored in a tangible computer-readable storage medium and executed using a processor of a computing device (e.g., the computing device 102, the server 120, or any combination of computing devices within the system 100). The routines may be included as part of any of the modules described in relation to FIG. 1, above, or FIG. 7, below, or as part of a module that is external to the system illustrated by FIGS. 1 and 7. For example, the method 600 may be part of a browser application or an application running on the computing device 102 as a plug-in or other module of the browser application. Further, the method 600 may be employed as “software-as-a-service” to provide a computing device 102 with access to the data system 104.

At function 601, the system 100 may execute an instruction to receive survey data 128, as described above in relation to FIG. 1 (e.g., via a computing device 108c, an on-line survey, telephonically, in-person, etc.) In some embodiments, the system 100 may receive data 128 over time and as new customers participate in the survey or become new customers, or data is otherwise received for the system 100. Receiving data and the determining segment function 602 may include a nearly continuous feedback loop whereby customers associated with the system 100 may be finely segmented over the life of the system 100.

At function 602, the system 100 may execute an instruction to determine a segment 200 for a particular customer or potential customer, a group of customers or potential customers, or other combination. As described above, the method 600 may employ some combination of psychographic, demographic, behavior, and needs-based segmentation for the customer. In some embodiments, the system 100 may access needs-based survey data 128 and employ a segmentation tool 112 to determine a customer segment. A tool 112 may correlate numerical values 320a1 from survey responses 320 to determine a score for a customer taking the survey from the user interface 300. In some embodiments, the segmentation tool 112 may present a user interface 300 for survey data 128 to a user at a client computing device via a web interface, or during a telephone interview, an in-person meeting, or other method. As described above, the user interface 300 may present questions including a mix of needs-based questions and demographics or objective questions. In some embodiments, the survey includes sixteen needs-based questions and two objective questions.

The function 602 may then execute a clustering algorithm to show various groups of customers having similar responses. Once clustered, function 602 may execute a hierarchical analysis followed by K-means analysis of the survey results to produce the various segments, as described herein, and classify a customer as a member of a particular segment. In some embodiments, the method 600 may repeat function 602 a statistically significant number of times. For example, function 602 may be repeated for a large sample of current or potential customers (e.g., five-thousand or more) such that the responses to the questions 320 result in an accuracy of 1.1% to a 95% confidence level. The sample may be representative of the US population and weighted by a series of demographics questions and other objective factors. Function 602 may also communicate the responses to the questions 310, including the numerical values 320a1 corresponding to the responses 320, to the data system 104 via the computer network 106.

At function 604, the method 600 may determine the most important needs of a customer within a particular segment at various interaction points for the business. In some embodiments, function 604 may employ the segmentation tool 112 to use various values 320a1 (FIG. 3) from the survey conducted by function 602 and determine the needs for each segment 200 at an interaction point. As described above in relation to FIG. 3, each question (needs-based 310a, demographic 310b, etc.) presented by the tool 112 may include a multiple choice response 320, where each choice corresponds to a value 320a1. Each needs-based question 310a may include a statement of how important personal interaction with an sales associate or agent of a business is to a current or potential customer. A response to such a question may indicate a degree of importance 320a for such interaction (e.g., a “strongly agree” response to a needs-based question 310a may indicate that the need expressed by the question is a prerequisite business behavior that the business must follow for the customer or segment of customers corresponding to that response). An objective or demographics question 310b may include statement or question of facts about the customer such as age, residence zip code, number of dependents living at home, etc. Possible responses to demographics questions 310b may indicate choices to satisfy the question's fact statement. Each response 320a may also correspond to one or more numerical values 320a1. Further, each question 310 may correspond to one or more categories of potential customer needs 420 as well as one or more interaction points 410 for the business. Function 604 may use the response values 320a1 for each question 310 corresponding to a customer need 420 and interaction point 410 to determine an interaction point need value 430. The interaction point value 430 may indicate an importance of a particular need 420 to a customer within a segment 200 during a particular interaction point 410.

At function 606, the method 600 may determine one or more behaviors to implement with a customer within a particular segment 200 based on the customer needs 420 corresponding to particular interaction points 410. In some embodiments, function 606 may use the value 430 determined by function 604 to select from one or more possible behaviors 520 during an interaction point 510 for the customer segment 200. For example, possible behaviors during a “Purchase” interaction point may include Call to Agent, Website, and Office Visit. These possible behaviors may correspond to a range of values 430 as determined by the system 100 for each segment 200 at function 602 and 604. For example, the Call to Agent behavior may correspond to a value between 0 and 33, the Website behavior may correspond to a value between 34 and 66, and the Office Visit behavior may correspond to a value between 67 and 100. The function 606 may compare the value 430 (or another value determined by the system 100 from the survey data 128) to the values associated with the behaviors to determine which behavior to assign to the interaction point 510 for the customers of that segment 200.

At function 608, the method 600 may implement the behavior determined at function 606. In some embodiments, implementing the behavior includes causing the system 100 to provide information to a customer within a particular segment 200 which allows the customer to implement the behavior. For example, to implement a “Call to Agent” behavior 520 during the “Quote” interaction point, the system 100 may either prompt an agent to call the customer or my simply provide a telephone number to the customer to allow the customer to call the agent. Further, to implement a “Website” behavior, the system 100 may implement one or more functions within a website for the business to facilitate that particular interaction point (e.g., provide a robust online payment system, information base, customer service chat application, etc.).

At function 610, the method 600 may determine whether one or more customers have changed segments. In some embodiments, the system 100 may periodically initiate the interface 300 for the segmentation tool 112 for each customer. In other embodiments, the system 100 may initiate the interface 300 when one of the answers to an objective question 310 is likely outdated (e.g., five years after a customer selects an age range of 30-34, etc.). If function 610 determines that a customer has changed segments, then function 610 may return to function 602 to begin the segmentation process for that customer. If function 610 determines that a customer has not changed segments, then function 610 may return to function 608 to continue implementing the same behaviors.

FIG. 7 is a high-level block diagram of an example computing environment for a system to segment a customer base and determine behaviors to implement to retain or expand customers for each segment during particular interaction points of the business. The computing device 701 may include a server 120, a client computing device 102 (e.g., a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example segmentation system 700 may be used to implement and execute the example system of FIG. 1, the example data structures or segments 200 of FIG. 2, the user interface of FIG. 3, the data structure 400 of FIG. 4, the data structure 500 of FIG. 5, the method 600 of FIG. 6, and the like. Although the example system 700 is described below as including a plurality of peripherals, interfaces, chips, memories, etc., one or more of those elements may be omitted from other example processor systems used to implement and execute the example system 100 including a segmentation tool 112 and interface 300. Also, other components may be added.

As shown in FIG. 7, the computing device 701 includes a processor 702 that is coupled to an interconnection bus 704. The processor 702 includes a register set or register space 706, which is depicted in FIG. 7 as being entirely on-chip, but which could alternatively be located entirely or partially off-chip and directly coupled to the processor 702 via dedicated electrical connections and/or via the interconnection bus 704. The processor 702 may be any suitable processor, processing unit or microprocessor. Although not shown in FIG. 7, the computing device 701 may be a multi-processor device and, thus, may include one or more additional processors that are identical or similar to the processor 702 and that are communicatively coupled to the interconnection bus 704.

The processor 702 of FIG. 7 is coupled to a chipset 708, which includes a memory controller 710 and a peripheral input/output (I/O) controller 712. As is well known, a chipset typically provides I/O and memory management functions as well as a plurality of general purpose and/or special purpose registers, timers, etc. that are accessible or used by one or more processors coupled to the chipset 708. The memory controller 710 performs functions that enable the processor 702 (or processors if there are multiple processors) to access a system memory 714 and a mass storage memory 716.

The system memory 714 may include any desired type of volatile and/or non-volatile memory such as, for example, static random access memory (SRAM), dynamic random access memory (DRAM), flash memory, read-only memory (ROM), etc. The mass storage memory 716 may include any desired type of mass storage device. For example, if the computing device 701 is used to implement a segmenting tool application 718 having an API 719 (including functions and instructions as described by the method 600 of FIG. 6), and user interface 520 to receive user input, the mass storage memory 716 may include a hard disk drive, an optical drive, a tape storage device, a solid-state memory (e.g., a flash memory, a RAM memory, etc.), a magnetic memory (e.g., a hard drive), or any other memory suitable for mass storage. In one embodiment, non-transitory program functions, modules and routines (e.g., an application 718, an API 520, and the user interface 520, etc.) are stored in mass storage memory 716, loaded into system memory 714, and executed by a processor 702 or can be provided from computer program products that are stored in tangible computer-readable storage mediums (e.g. RAM, hard disk, optical/magnetic media, etc.). Mass storage 716 may also include a cache memory 721 storing application data, user profile data, and timestamp data corresponding to the application data, and other data for use by the application 718.

The peripheral I/O controller 710 performs functions that enable the processor 702 to communicate with peripheral input/output (I/O) devices 722 and 724, a network interface 726, via a peripheral I/O bus 728. The I/O devices 722 and 724 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O devices 722 and 724 may be used with the application 718 to provide a segmentation tool 112 and web interface 300 as described in relation to the figures. The local network transceiver 728 may include support for Wi-Fi network, Bluetooth, Infrared, cellular, or other wireless data transmission protocols. In other embodiments, one element may simultaneously support each of the various wireless protocols employed by the computing device 701. For example, a software-defined radio may be able to support multiple protocols via downloadable instructions. In operation, the computing device 701 may be able to periodically poll for visible wireless network transmitters (both cellular and local network) on a periodic basis. Such polling may be possible even while normal wireless traffic is being supported on the computing device 701. The network interface 726 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 712 and the I/O controller 710 are depicted in FIG. 7 as separate functional blocks within the chipset 708, the functions performed by these blocks may be integrated within a single integrated circuit or may be implemented using two or more separate integrated circuits. The system 700 may also implement the user interface 300 and segmentation tool 112 on remote computing devices 730 and 732. The remote computing devices 730 and 732 may communicate with the computing device 701 over a network link 734. For example, the computing device 701 may receive location data created by an application executing on a remote computing device 730, 732. In some embodiments, the application 718 including the user interface 300 and tool 112 may be retrieved by the computing device 701 from a cloud computing server 736 via the Internet 738. When using the cloud computing server 736, the retrieved application 718 may be programmatically linked with the computing device 701. The segmentation tool application 718 may be a Java® applet executing within a Java® Virtual Machine (JVM) environment resident in the computing device 701 or the remote computing devices 730, 732. The application 718 may also be “plug-ins” adapted to execute in a web-browser located on the computing devices 701, 730, and 732. In some embodiments, the application 718 may communicate with back end components 740 such as the data system 104 via the Internet 738 or other type of network.

Using the system 100 and method 600 described herein, a segmentation tool 112 and interface 300 coupled with the method 600 may implement a customer segmentation methodology to better service, retain, and expand a business' customer base. By implementing a need-state segmentation study facilitated by the tool 112, customers may be classified into various groups having particular needs. These needs may then be translated into specific business behaviors to service these particular types of clients. In an insurance business, this segmentation tool may then be used by agents as well as more remote parties. For example, a training program may educate all agents on identifying segments using the tool and tailoring their customer experience based on the identified needs and appropriate business behaviors. Call center and telephone representatives may user the segmentation tool 112 and interface 300 coupled with customized scripts to address the particular needs of customers within identified segments. Likewise, the online experience of each customer may be enhanced to ensure customer needs are met and behaviors are addressed though customized, web-based interaction.

The following additional considerations apply to the foregoing discussion. Throughout this specification, plural instances may implement functions, components, operations, or structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the network 112, may include but is not limited to any combination of a LAN, a MAN, a WAN, a mobile, a wired or wireless network, a private network, or a virtual private network. Moreover, while only one client computing device is illustrated in FIG. 1 to simplify and clarify the description, it is understood that any number of client computers or display devices are supported and can be in communication with the data system 104.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain functions. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or functions described herein may be at least partially processor-implemented. For example, at least some of the functions of a method may be performed by one or processors or processor-implemented hardware modules. The performance of certain of the functions may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors), these operations being accessible via a network (e.g., the Internet) and via one or more appropriate interfaces (e.g., application program interfaces (APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or an “algorithm” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a computer system 100 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for segmenting a customer base and implementing specific behaviors for each customer segment through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for segmenting a business' customer base and determining one or more business behaviors toward customers based on the segmentation, the method comprising:
communicating a survey to a plurality of customers via a computer network, the survey including at least one needs-based question and at least one demographics question, wherein the needs-based question indicates a customer preference for a business behavior and the demographics question indicates an objective fact about a customer;
receiving survey data in response to the survey questions via the computer network, the survey data including a plurality of customer data sets, each set including numerical values corresponding to each response to the survey questions;
grouping, at one or more processors, the received survey data into a plurality of segments;
classifying, at one or more processors, each of the plurality of customers into one of the plurality of segments based on the numerical values corresponding to each response to the survey questions for a customer data set, wherein the numerical values for each customer data set identify one of the plurality of segments;
calculating, with one or more processors, an interaction point need value by analyzing the received survey data, wherein the interaction point need value indicates particular categories of business characteristics that the customers classified in each of the plurality of segments may find helpful during each of a plurality of interaction points;
selecting, with one or more processors, for each of the plurality of interaction points a preferred business behavior from a plurality of business behaviors practiced by the business for each of the plurality of segments based on the interaction point need value for each interaction point, wherein the interaction point including a service during an ongoing business relationship; and
implementing, at one or more processors, at least one of the determined prerequisite business behaviors at each interaction point.

2. The computer-implemented method of claim 1, wherein the survey questions include multiple choice questions, each choice corresponding to a numerical value.

3. The computer-implemented method of claim 2, wherein each choice for the at least one needs-based question indicates a degree of importance for the customer preference for the business behavior corresponding to the needs-based question.

4. The computer-implemented method of claim 1, wherein grouping the survey data into the plurality of segments further includes clustering the survey data.

5. The computer-implemented method of claim 4, wherein grouping the survey data into the plurality of segments further includes executing a hierarchical analysis followed by a K-means analysis of the received survey data.

6. (canceled)

7. The computer-implemented method of claim 1, wherein the business behavior satisfies the one or more needs of each customer based on the segment corresponding to the customer.

8. A computer device for segmenting a business' customer base and determining one or more business behaviors toward customers based on the segmentation, the computer device comprising:
one or more processors; and
one or more memories coupled to the one or more processors;
wherein the one or more memories include computer executable instructions stored therein that, when executed by the one or more processors, cause the one or more processors to:
communicate a survey to a plurality of customers, the survey including at least one needs-based question and at least one demographics question, wherein the needs-based question indicates a customer preference for a business behavior and the demographics question indicates an objective fact about a customer;
receive survey data in response to the survey questions, the survey data including a plurality of customer data sets, each set including numerical values corresponding to each response to the survey questions;
group the received survey data into a plurality of segments;
classify each of the plurality of customers into one of the plurality of segments;
calculate an interaction point need value, wherein the interaction point need value indicates particular categories of business characteristics that the customers classified in each of the plurality of segments may find helpful during each of a plurality of interaction points;
select for each of the plurality of interaction points a preferred business behavior from a plurality of business behaviors practiced by the business for each of the plurality of segments based on the interaction point need value for each interaction point, wherein the interaction point including a service during an ongoing business relationship; and
cause at least one of the determined prerequisite business behaviors to be implemented at each interaction point.

9. The computer device of claim 8, wherein the survey questions include multiple choice questions, each choice corresponding to a numerical value, and each choice for the at least one needs-based question indicates a degree of importance for the customer preference for the business behavior corresponding to the needs-based question.

10. The computer device of claim 8, wherein the instructions to group the survey data into the plurality of segments further include instructions to cluster the survey data and execute a hierarchical analysis followed by a K-means analysis of the received survey data.

11. The computer device of claim 8, wherein the instructions to classify each of the plurality of customers includes instructions to correlate the numerical values for each customer data set to determine a score for each customer data set, wherein the score corresponds to one of the plurality of segments.

12. (canceled)

13. The computer device of claim 8, wherein the business behavior satisfies the one or more needs of each customer based on the segment corresponding to the customer.

14. A tangible computer-readable medium including non-transitory computer readable instructions stored thereon for segmenting a business' customer base and determining one or more business behaviors toward customers based on the segmentation, the instructions comprising:
communicating a survey to a plurality of customers, the survey including at least one needs-based question and at least one demographics question, wherein the needs-based question indicates a customer preference for a business behavior and the demographics question indicates an objective fact about a customer;
receiving survey data in response to the survey questions, the survey data including a plurality of customer data sets, each set including numerical values corresponding to each response to the survey questions;
grouping the received survey data into a plurality of segments the received survey data by clustering the survey data and executing a hierarchical analysis followed by a K-means analysis of the received survey data;
classifying each of the plurality of customers into one of the plurality of segments;
calculate an interaction point need value, wherein the interaction point need value indicates particular categories of business characteristics that the customers classified in each of the plurality of segments may find helpful during each of a plurality of interaction points;
select for each of the plurality of interaction points a preferred business behavior from a plurality of business behaviors practiced by the business for each of the plurality of segments based on the interaction point need value for each interaction point, wherein the interaction point including a service during an ongoing business relationship; and
implementing at least one of the determined prerequisite business behaviors at each interaction point.

15. The tangible computer-readable medium of claim 14, wherein the survey questions include multiple choice questions, each choice corresponding to a numerical value.

16. The tangible computer-readable medium of claim 15, wherein each choice for the at least one needs-based question indicates a degree of importance for the customer preference for the business behavior corresponding to the needs-based question.

17. The tangible computer-readable medium of claim 14, wherein the instructions to group the survey data into the plurality of segments further include instructions to cluster the survey data and execute a hierarchical analysis followed by a K-means analysis of the received survey data.

18. The tangible computer-readable medium of claim 14, wherein the instructions to classify each of the plurality of customers includes instructions to correlate the numerical values for each customer data set to determine a score for each customer data set, wherein the score corresponds to one of the plurality of segments.

19. (canceled)

20. The tangible computer-readable medium of claim 14, wherein the business behavior satisfies the one or more needs of each customer based on the segment corresponding to the customer.

21. The computer-implemented method of claim 1, wherein the service during the ongoing business relationship includes one or more of researching an insurance product, obtaining a quote for a type of insurance, issuing an agreement of coverage before or while the business issues an insurance policy to the customer, filing a claim against an issued insurance policy, or amending or editing an issued insurance policy.

22. The computer device of claim 8, wherein the service during the ongoing business relationship includes one or more of researching an insurance product, obtaining a quote for a type of insurance, issuing an agreement of coverage before or while the business issues an insurance policy to the customer, filing a claim against an issued insurance policy, or amending or editing an issued insurance policy.

23. The tangible computer-readable medium of claim 14, wherein the service during the ongoing business relationship includes one or more of researching an insurance product, obtaining a quote for a type of insurance, issuing an agreement of coverage before or while the business issues an insurance policy to the customer, filing a claim against an issued insurance policy, or amending or editing an issued insurance policy.
